(19) United States
(12) Patent Application Publication
(10) Pub. No.: US 2008/0208876 A1
(43) Pub. Date: Aug. 28, 2008

(54) Method of and System for Providing Random Access to a Document

(75) Inventor: Michael John Stoner, Hove (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,529

(22) PCT Filed: Mar. 28, 2006
(86) PCT No.: PCT/IB06/50935

§ 371 Date: Oct. 3, 2007

(30) Foreign Application Priority Data
Apr. 6, 2005 (EP) 05102692.0

(51) Int. Cl. G06F 17/30

(52) U.S. Cl. 707/100; 707/E17.009

(57) ABSTRACT

The invention relates to a method and a system (101) for providing random access to documents, in particular large XML documents. Thus, the invention addresses the problem that current XML processors either can not provide random access to large XML documents, or that they can provide random access, however at a speed far to slow to be user friendly. The method proposes to generate Random Access Points to a document and to store these Random Access Points in a separate storage means (130). These Random Access Points indicate the start and/or end of fragments of the document being parsed Store Doc and provide a means by which fragments of the document can be accessed randomly.

This invention relates to a method of providing random access to the content of a document in a computer device. The invention moreover relates to a system for providing random access to the content of a document and to a computer program comprising program code means adapted to cause a data processing device to perform the method of the invention.

Data can be marked up in a plurality of ways, e.g. by means of XML. The design goal for XML was to allow the publishing of information on the Internet. However, XML can also be used to allow the storage of data that does not rely on any specific application.

A document can be published and/or stored in XML and even though the current ways of viewing the document becomes unavailable, the XML structure will make it possible to view the document again with minimum effort.

Moreover, it has turned out that XML provides more advantages that foreseen in the design phase thereof; e.g. can logging, analysis and rendering of data can be particularly advantageous. Throughout this specification, the term “render” is meant to cover any displaying of content on a screen or display of a computer device or any other accessing of content on a computer device.

However, random access or non-serial access to large XML documents is presently not very system and/or user friendly, if possible at all, as will be explained below.

Access to an XML document is typically performed by means of an XML Processor. Most XML processors are limited to just two kinds APIs (Application Program Interfaces), viz. tree-based and event-based APIs.

Tree-based APIs map an XML document into an internal tree structure for subsequent navigation through the tree by means of an application. A well-known example of such a tree-based API is DOM (Document Object Model). Tree-based APIs are useful for a wide range of applications, but they normally put a great strain on system resources, especially if the document is large. Furthermore, many applications need to build their own strongly typed data structures rather than using a generic tree corresponding to an XML document. It is inefficient to build a tree of parse nodes, only to map it onto a new data structure and then discard the original.

Event-based APIs do not usually build an internal tree. Instead event-based APIs report parsing events (such as the start and end of elements) directly to the application through callbacks, and do not usually build an internal tree. The application implements callback event handlers to deal with the different events. An event-based API provides a simpler, lower-level access to an XML document than a tree-based API: it is possible to parse documents much larger than the available system memory, and it is possible to construct data structures using the callback event handlers. The best-known example of such an event-based API is SAX (Simple API for XML).

In the case of large XML documents, it is very time-consuming and maybe even impossible to obtain non-serial access to the XML documents, e.g. using a random access GUI (graphical User Interface), as will be explained below. Even when it is possible to obtain non-serial access to the XML documents, the speed used by a computer device for navigating through the XML document can be much to slow for human interaction. This is true for both event-based and tree-based APIs, as will be explained below, even if the reasons for it are different in the two cases.

As mentioned, with tree-based APIs, a tree is built and has to be retained in the memory of a computer device. This tree normally uses about ten times as much memory capacity as the original XML document. Moreover, the use of a tree-based API necessitates the parsing of the whole document before anything can be shown to a user. Thus, if the XML document itself is large, the tree built over the XML document can become excessively large and might have a performance impact on the operating system of the computer device.

With event-based APIs serial access to an XML document is possible. Hereby, a user can move forward through the XML document in a sufficiently user-friendly speed. However, if a user wants to move backwards in the XML document, the reverse in the flow of the document means that the XML document will have to be parsed from the start of the XML document to the point in the XML document selected by the user. The time taken to do this depends on the read access time of the storage of the computer device and the parsing speed of the event-based API as well as the speed of the application used to view the XML document. Thus, random access to large XML documents by means of an event-based API typically is possible, but typically also too slow for user interaction.

Thus, it is a problem that XML and the present XML APIs do not provide the possibility to provide random access or non-serial access to large XML documents.

It is therefore an object of the invention to provide a method and a system of providing non-serial access to large XML documents. It is another object of the invention to provide a faster access to and/or search through large XML documents. These and other objects are obtained, when the method of the kind mentioned in the opening paragraph comprises the following steps: storing the document in a first storage means; parsing the document in order to generate Random Access Points (RAP) indicating the start and/or of the end of fragments of the document; and storing the Random Access Points (RAP) in a second storage means.

Since the start and/or the end of the fragments of the document are indicated by means of Random Access Points, these fragments can be accessed randomly, i.e. non-serially. The document is stored in a first storage means, and the Random Access Points are stored in a second storage means. However, the first storage means and the second storage means could be different sections of one and the same storage means. It should be noted that the term “indicate the start and/or end of fragments” is meant to be synonymous to the term “indicate the location of the start and/or end of fragments” and to the term “indicate the position of the start and/or end of fragments”.

In a preferred embodiment of the method according to the invention, it further comprises the step of storing selected fragments of the document in a third storage means. Hereby, it is possible to search through these selected fragments faster, in that only selected fragments are stored therein. Thus, this third storage means can be smaller than the first storage means, whereby the time for searching fragments or data therein is decreased. The fragments to be stored in the third storage means are configurable so that the speed versus size ratio can be adjusted.

In a preferred embodiment of the method, the document is an XML document comprising one or more XML objects. Hereby, the method provides random access to XML documents which has not yet been possible without excessive use of storage capacity.

In another preferred embodiment, the document comprises one or more objects in native format and the method comprises the step of converting said objects in native format into an XML document comprising one or more XML objects. Hereby, a document with objects in native format can be processed to provide an XML document with Random Access Points.

In one preferred embodiment of the method, the document is stored in a persistent storage means prior to parsing thereof. In an alternative preferred embodiment of the method, it further comprises the step of: receiving the document in fragments; wherein the steps of parsing and storing said document is performed successively on said fragments. Hereby, the method can work with streamed documents or documents that are being generated as a part of a process. The method just process the documents received, parse them, store them and index them (i.e. generate Random Access Points to them). The method does not need a complete document to be accessible, only complete fragments of the document, i.e. fragments having an end and a start, e.g. one or more XML objects.

Preferably, the size of the XML document is more than 10 MB, preferably more than 30 MB, more preferably more than 50 MB, and most preferably more than 100 MB. With documents of these sizes the method is particularly advantageous for providing random access, in that no other XML processors able to access documents of these sizes randomly exist.

In a preferred embodiment, the random access points are children of the root of said XML document. This provides an especially easy way of indexing the XML document, in that the random access points are readily available.

In an alternative preferred embodiment, the random access points are indicated via a document description of said document.

In yet a preferred embodiment the method further comprises the step of rendering the document by means of an application on the computer device. Such an application could be a Graphical User Interface (GUI) that requires random access to a document for a user to navigate in the document via the GUI.

The invention moreover relates to a system and a computer program arranged to perform the method according to the invention having similar advantages as the method described above.

Throughout this specification, the term “large XML document” is meant to cover any XML document having a size that makes it difficult or impossible to render or view by means of a random access GUI. In absolute terms, such a size could be XML documents of a size of 10 MB to 100 MB or more. Moreover, the term “to generate Random Access Points” is meant to be synonymous to “to index” and the term “random access” is meant to be synonymous to “non-serial access”. Finally, it should be noted that throughout this specification a “document” can include one or more “fragments” that on the other hand can include one or more “objects”.

The invention will be explained more fully below in connection with preferred embodiments and with reference to the drawing, in which:

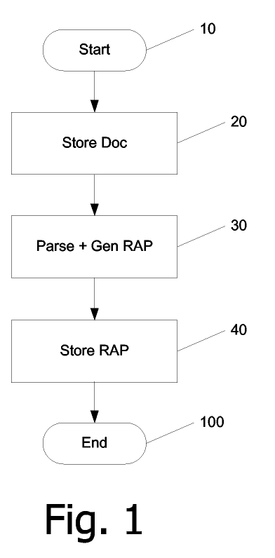

FIG. 1 is a flow chart of an embodiment of the method according to the invention;

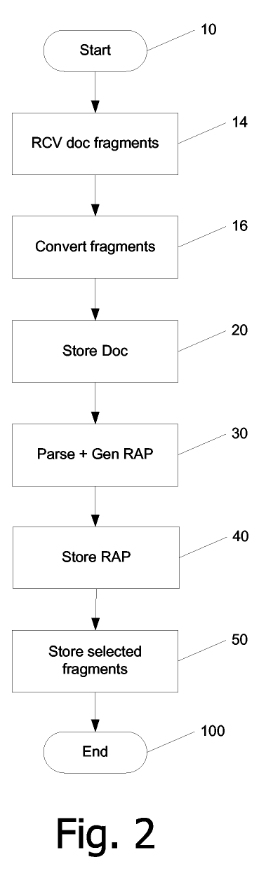

FIG. 2 is a flow chart of an alternative embodiment of the method according to the invention;

FIG. 3 shows a system according to the invention; and

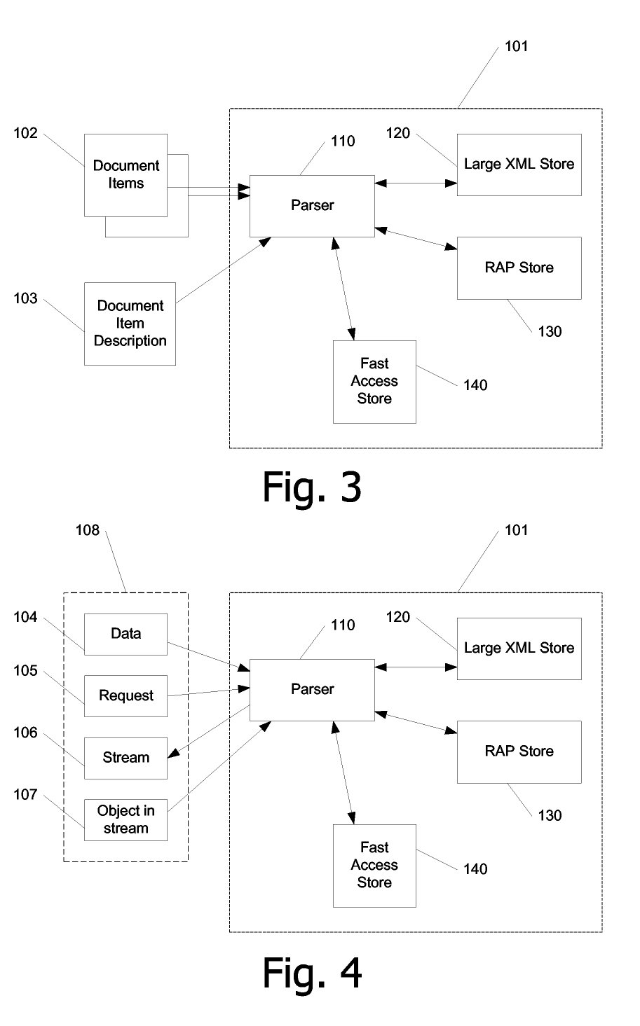

FIG. 4 is a schematic diagram of a system according to the invention receiving data in other format than XML.

The following description of the figures is related to the example of XML documents, which is not to be construed as limiting the scope of the invention.

FIG. 1 is a flow chart of an embodiment of the method according to the invention. The method can be carried out in any document in any computer device. The flow starts in step 10 and continues to step 20, wherein a document is stored in a first storage means, a so-called “Large XML Store”. The flow continues to the next step, step 30, wherein the document is parsed in order to generate Random Access Points (RAP) indicating the start and/or end of fragments of the document. The Random Access Points (RAPs) could be indicated in a document description of the document. In case of the document being an XML document, the Random Access Points (RAPs) could be the children of the root of the XML document. However, other possibilities are conceivable too. The parsing does not change document stored in the Large XML Store, since the parsing is a read only operation. In the subsequent step, step 40, the Random Access Points (RAPs) are stored in a second storage means, a “RAP Store”. Hereby, the RAP Store contains indexes, i.e. the RAPs, indicating the start and/or end of fragments of the document. This can be used by any application requiring random access to the XML document, so that random access to each fragment is possible. The flow continues to step 100, wherein it ends.

The flow in FIG. 1 could be extended to comprise a further step (not shown) of a further storage after the step 20 of parsing the document and generating RAPs. This further storage could be conceivable, if many XML documents were to be added together to form one large XML document, where each of these XML documents initially was stored separately.

FIG. 2 is a flow chart of an alternative embodiment of the method according to the invention. The steps of the flow chart in FIG. 1 are included as steps in the flow chart in FIG. 2; therefore, these steps are not described in detail here. Again, the method shown in FIG. 2 can be carried out on any computer device. The flow in FIG. 2 starts in step 10 and continues to step 14, wherein document fragments are received. The document fragments could e.g. be streamed from another computer devices interconnected, e.g. via the Internet, to the computer device on which the method is carried out or they could be received successively from an application running on the computer devices. The next step, step 16, is optional in the way that, if the document fragments received in step 14 were in XML format, step 16 is skipped. However, if the document fragments received in step 14 are in another format than XML, e.g. if they are objects in native format, such as C++ objects, Java class instants or C data structures, step 16 is carried out. In step 16, the fragments received in step 14 are converted to an XML document comprising one or more XML objects. Each object in native format could be converted into an XML object, or more than one object in native format could be converted into an XML fragment comprising more than one XML object. Hereafter, the flow continues to the steps 20, 30 and 40, which already have been described in relation to FIG. 1. Subsequently, the flow continues to step 50, wherein selected fragments are stored in a third storage means, a Fast Access Store. Thus, the selected fragments stored in the Fast Access Store can be searched faster than the Large XML Store containing the totality of fragments. Step 50 can be performed in many ways, but a particularly advantageous way is to store the Random Access Point of the Large XML Store in the Fast Access Store, and to store the Random Access Points of the Fast Access Store in a RAP document. This RAP document points to Fast Access Store, the Fast Access Store comprises the search text, and the Random Access Points point into the Large XML Store. However, the RAP document could alternatively contain the Random Access Points for both the Large XML Store and for the Fast Access Store. Moreover, Random Access Points are also needed for the random access into the Fast Access Store. Thus, the Random Access Point Store is designed so that these Random Access Points can also be stored there. The flow ends in step 100.

It should be noted that the method shown in FIG. 1 could be combined with the steps 14 and 16 shown in FIG. 2 and/or with step 50 shown in FIG. 2.

FIG. 3 shows a system 101 according to the invention for creating random access to XML documents, preferably large XML documents. The components of the system 101 are components in a computer device. The system 101 comprises a parser 110 which receives Document Items 102. The Document Items 102 could be whole XML documents received from a persistent storage means of the computer device after a read message. Alternatively, the Document Items 102 could be fragments of XML documents, e.g. output of a real time system in XML format, or objects in native format, e.g. Java class instants, C++ objects or C data structures. In case of the Document Items being in another format than XML, a conversion will have to take place as will be described below in connection with the description of FIG. 4.

Moreover, Document Item Descriptions 103 relating to the document items 102 could be transferred to the parser 110. The Document Item Description 103 can comprise indications of preferred Random Access Points to the document items 102, indications of whether a document item 102 should be stored in a Fast Access Store 140 of the system 101, etc. In general, the Document Item Description describes the object so that the object can be converted to a document in XML format. The object and the resulting XML document can be variable in length. The parser 110 is arranged to parse the received documents items 102 in order to generate Random Access Points indicating the start and/or end of fragments of the document items 102. If a Document Item 102 already has been parsed in order to generate the Random Access Points, these RAPs can be transferred to the Parser 100.

The Parser 110 is connected to a first storage means, a Large XML Store 120, wherein the Document Items 102 in XML format are stored. The Parser 110 is moreover connected to a second storage means 130, a RAP Store, wherein the Random Access Points related to a document item 102 are stored. Finally, the Parser is connected to a third storage means 140, a Fast Access Store, wherein selected portions of Document Items 102 in XML format, or text, or binary are stored. Preferably, it should be possible to decide on the type of the Fast Access Store on an application basis. In one application, the Fast Access Store comprises text so that a Graphical User Interface is possible wherein a user could make queries such as “I wish to find all objects that have a field call “Datum”, containing text “apple””. For example, the Fast Access Store could comprise the indexes to XML fragments in the Large XML Store as well as information in the form <tag> value </tag> in text format. This can be done as shown in the following:

First number: Start of an XML fragment

Second number: End of the XML fragment

Third number: number of tag value pairs

Tag

Value

which can be repeated.

An example of the above structure could be:

000000

000104

000002

First Tag

“This is the value of the First Tag”

Second Tag

“This is the value of the Second Tag”

000105

000235

000001

Tag

“This is the value of Tag”

000236

..

..

Hereby, the information sought can easily and quickly be found by means of the Fast Access Store.

The Parser can enquire the RAP Store 130 to obtain a RAP to a fragment of an object of a Document Item 102. This RAP will indicate a position of a Document Item 102 in the Large XML Store 120 or in the Fast Access Store 140, which subsequently can be read at the indicated position. Thus, random access is obtained to the Document Items 102. The Document Items 102 stored in the Fast Access Store 140 can be searched even faster than the Document Items in the Large XML Store 120 in that the content of the Fast Access Store is smaller than the content of the Large XML Store. The Parser 110 can be implemented in any processor means of the computer device, and the Large XML Store 120, the RAP Store 130 and the Fast Access Store 140 can be any appropriate storage media.

FIG. 4 is a schematic diagram of a system according to the invention receiving data in other format than XML. The system 101 comprises the elements described in connection with FIG. 3; however, the Parser 110 is arranged to carry out slightly different method steps compared to FIG. 3 as will be explained below. In FIG. 4 a Sender System 108 is in communication with the system 101 and uses the system 101 for logging output. The Sender system 108 passes data 104 about objects in native format, e.g. C++ objects, which objects are to be logged. The data 104 could be Document Item Description as described in relation to FIG. 3, including information on which objects should be stored in the Fast Access Store 140 of the system. This Data 104 is in XML format. The Sender System 108 moreover transmits a request 105 for a stream 106. This stream 106 could e.g. be any identifier or number.

The system 101 can be implemented as a dynamically linked library and the sender system 108 can make calls upon 101 by using the exported functions form the dynamically linked library. Thus, requesting a stream results in the return of an identifier or a number. Hereafter, an object 107 can be added to the stream. In this case, the identifier or number should be stated together with the object to add.

It is possible for the systems 108 and 101 to have a plurality of streams at the same time, wherein any stream carries a distinct set of files. When the stream between the System 101 and the Sender System 102 is established, the sender system 108 sends objects 107 in native format in the stream to the parser in the system 101. The parser 110 converts the received objects to XML and store the converted XML objects in the Large XML Store 120, one per stream. Subsequently, the parser 110 reads the converted XML objects and generates two files for each stream between the Sender System 108 and the system 101. The first file contains Random Access Points for files to be stored in the Fast Access Store 140 and the second file contains Random Access Points for the objects stored in the Large XML Store. The parser 110 generates these files by use of the Data 104 comprising Document Item Descriptions.

With the method described in relation to FIGS. 1 and 2 and the system 101 described in relation to FIGS. 3 and 4 it is possible to obtain random access to fragments and objects of XML documents; moreover, different fragments and/or objects of XML documents can be treated differently. As described a faster search is also possible due to the Fast Access Store.

### EXAMPLES

In the following, examples of the Document Items 102 and the Data 104 are given to show possible formats thereof.

Firstly, in examples 1 and 2, the data items “apples are green” and “oranges are orange” are transmitted as in XML format in two ways:

### Example 1

1a. Full1

<?xml version = “1.0” encoding = UTF-16”?>

<dataItem>

<datum> apples are green </datum>

</dataItem>

1b. Full2

<?xml version = “1.0” encoding = UTF-16”?>
<dataItem>

<datum> oranges are orange </datum>

</dataItem>

### Example 2

2a. Frag 1

<dataItem>

<datum> apples are green </datum>

</dataItem>

2b. Frag 2

<dataItem>

<datum> oranges are orange </datum>

</dataItem>

When each data item is presented as an XML document such as in the above example 1a and 1b, the XML declaration (i.e. “<?xml version=“1.0” encoding=UTF-16”?>”) should be stripped from each data item in the XML document, in that the final output XML document should only contain one XML declaration. When presented as fragments as in example 2a and 2b, the XML declaration must be added once again to the final XML document to be stored in the Large XML Store.

### Example 3

In the following two different types of C++ interfaces are shown, where each C++ interface allows the data items “apple are green” and “oranges are orange” to be sent not as XML but as C++ objects.

3a. class IlogInterfaceSelfContained
{
public:

virtual ~ IlogInterfaceSelfContained ( ) { }
virtual std:::string getName( ) = 0;
virtual std:::string getValue( ) = 0;
virtual std:::string is ToUseFastSearch ( ) = 0;
virtual int getNumberOfChildren ( ) = 0;
virtual IlogInterfaceSelfContained * getChildAtIndex
(int childIndex) = 0;

};
3b. class IlogInterface
{
public:

virtual ~ IlogInterface ( ) { }
virtual std:::string getName( ) = 0;
virtual std:::string getValue( ) = 0;
virtual std:::string is ToUseFastSearch ( ) = 0;
virtual int getNodeStringValue (std:::string
node name) = 0;
virtual IlogInterface * getNodeRefValue (std:::string
node name) = 0;

};

In the example 3a, the system 101 would receive the object, call getName, “dataltem”, and store this as the starting tag. Then the system 101 would get each child via the getChildAtIndex( ), reading the name “datum” and values “apple are green” and using this to generating the XML, storing this in the Large XML Store 120. The next object sent would contain the value “oranges are orange” and would also be stored.

In example 3b, the system 101 would call getName, “dataltem”, and thereafter the system 101 would use the Document Item Description 103 to discover the names of the children of “dataltem” which are “datum”. Subsequently, the system 101 would call getNodeString (“datum”) and getNodeRefValue (“datum”), and one of these would return the value “apples are green”.

Each class is used to generate an output XML document; the first class can generate the output XML document from the class alone, whereas the second class needs an additional description. In the examples 3a and 3b, the function “ToUseFastSearch” is intended to allow the system to know which fragments or objects of the XML document that are to be indexed, i.e. for which fragments or objects Random Access Points should be generated. This function could be removed from the interface and the information could be placed in the Document Item Description as explained in connection with the description of FIG. 3. In the examples 1 and 2 above, fragments that are to be added to the Fast Access Store 140 may be specified by means of a specific tag or attribute or it may be in a separate XML document. Below the examples 4-8 give examples of how it can be indicated that data are to be indexed to the Fast Access Store is given:

### Example 4

<dataItem FastAccess = “yes”>
<datum> apples are green </datum>
</dataItem>

### Example 5

<dataItem>
<datum FastAccess = “yes”> apples are green </datum>
</dataItem>

### Example 6

<dataItem index = “yes”>
<datum FastAccess = “yes”> apples are green </datum>
</dataItem>

### Example 7

```
<dataItem>
        <FastAccess>
            <datum> apples are green </datum>
        </FastAccess>
</dataItem>
```

### Example 8

```
<dataItem>
        <datum>
            <FastAccess >
                apples are green
            </FastAccess>
        </datum>
</dataItem>
```

The system 101 can parse the XML documents as exemplified in Examples 4 to 8 to generate files to be stored in the Fast Access Store 140. During the parsing of document items in XML format, the exact location/position of the XML fragments become available as the Random Access Points hereby providing random or non-serial access to the XML document items/fragments.

The system 101 could use the XML fragments directly. In this case the only XML document item handled by the system 101 is the XML document stored in the Large XML Store 120. Alternatively, after retrieval of a fragment of an XML document, the system could wrap this fragment and thus generate an XML document. This newly generated XML document could be used, given access to, displayed, etc.

The system could use a coded display routine. It may translate an XML document in any way required by a user of e.g. a logging system. A more generic system may rely on the fact that the Large XML Store contains information in XML format and that many tools exist for transforming and rendering documents in XML format. Thus, a generic logging system could be designed where the rules for the displaying/rendering of logged data/document items could be changed during runtime. This would allow a more flexible approach to the use of the logging system; e.g. with a Cascading Style Sheet One (CSS1), Cascading Style Sheet Two (CSS2) or XSLT (extensible Stylesheet Language Transformation).

It should be emphasized that the term “comprises/comprising” when used in this specification is taken to specify the presence of stated features, integers, steps or components but does not preclude the presence or addition of one or more other features, integers, steps, components or groups thereof. The mere fact that certain measures are recited in mutually different dependent claims or described in different embodiments does not indicate that a combination of these measures cannot be used to advantage.

1. A method of providing random access to the content of a document in a computer device, characterized in comprising the following steps:
storing (20) the document in a first storage means (120); and
parsing (30) the document in order to generate Random Access Points (RAP) indicating the start and/or of the end of fragments of the document;
storing (40) the Random Access Points (RAP) in a second storage means (130).

2. A method according to claim 1, characterized in further comprising the step of:
storing (50) selected fragments of the document in a third storage means (140).

3. A method according to claim 1, characterized in that the document is an XML document comprising one or more XML objects.

4. A method according to claim 3, characterized in that the document comprises one or more objects in native format and that the method comprises the step of converting (16) said objects in native format into an XML document comprising one or more XML objects.

5. A method according to claim 1, characterized in that the document is stored in a persistent storage means prior to parsing thereof.

6. A method according to claim 1, characterized in further comprising the step of:
receiving (14) the document in fragments,
wherein the steps of parsing and storing said document is performed successively on said fragments.

7. A method according to claim 3, characterized in that the size of the XML document is more than 10 MB, preferably more than 30 MB, more preferably more than 50 MB, and most preferably more than 100 MB.

8. A method according to claim 3, characterized in that the random access points are children of the root of said XML document.

9. A method according to claim 1, characterized in that the random access points are indicated via a document description (103) of said document.

10. A method according to claim 1, characterized in that the method further comprises the step of:
rendering the document by means of an application on the computer device.

11. A system (101) for providing random access to the content of a document, comprising:
a first storage means (120) for storage of said document;
parsing means (110) for parsing said document in order to generate Random Access Points (RAP) indicating the start and/or the end of fragments of said document; and
a second storage means (130) for storage of said Random Access Points (RAP).

12. A system (101) according to claim 11, characterized in further comprising:
a third storage means (140) for storing selected fragments of said document.

13. A system (101) according to claim 11, characterized in that the document is an XML document comprising one or more XML objects.

14. A system (101) according to the claim 13, characterized in that the size of the XML document is more than 10 MB, preferably more than 30 MB, more preferably more than 50 MB, and most preferably more than 100 MB.

15. A system (101) according to claim 13, characterized in that the random access points are children of the root of said XML document.

16. A system (101) according to claim 11, characterized in that the random access points are indicated via a document description (103) of said document.

17. A computer program comprising program code means adapted to cause a data processing device to perform the steps of the method according to claim 1, when said computer program is run on the data processing device.
